(19) United States
(12) Patent Application Publication
(10) Pub. No.: US 2007/0222242 A1
(43) Pub. Date: Sep. 27, 2007

(54) Vibrating manure fork

(76) Inventor: Richard Dean Daniels SR., Zephyrhills, FL (US)

Correspondence Address: Robert C. Brown, 1207 Sandhurst Drive, Tallahassee, FL, 32312, US

(21) Appl. No.: 11/387,647

(22) Filed: Mar. 23, 2006

(51) Int. Cl. A01D 9/00

(52) U.S. Cl. 294/55.5

(57) ABSTRACT

A manure fork comprising a handle and a fork arrangement including a shank terminating in a plurality of spaced-apart tines. The tines are integral with the shank at their inner ends and are free at their outer ends. A vibrator is incorporated into the manure fork a point near the juncture of the handle and shank. The vibrator includes a DC electric motor having an eccentric weight mounted on its shaft. The motor is battery powered by a rechargeable battery source. A switch is provided on the handle in proximity to either of an operator's hands so the motor may be energized when vibration is desired and de-energized to conserve battery power during scooping or dumping. Preferably, the vibrator is an auxiliary module attachable to convert a prior art manure fork into a improved manure fork. Alternatively, the vibrator may be incorporated permanently on or within the handle.

### TECHNICAL FIELD

The present invention relates to devices for handling animal waste products; more particularly, to such devices known generally as manure forks for cleaning out soiled bedding from animal stalls; and most particularly, to a manure fork having means for vibrating the tines thereof to provide rapid and thorough separation of manure from still-useful bedding.

### BACKGROUND OF THE INVENTION

In animal husbandry, it is common practice to confine animals in enclosures known variously as stalls, cages, or compounds, referred to herein generically as stalls. The floors of animal stalls typically are covered with a layer of sacrificial material known generally as bedding, to absorb and permit intermittent removal of animal feces and urine. Such bedding may comprise, for example, straw, wood chips, shredded wood, sawdust, clays, ground corn cobs, and the like.

Bedding becomes soiled by defecation and urination at frequent intervals and therefore must be renewed frequently. Renewal is typically performed manually by first collecting and then replacing all bedding and manure using a pitchfork having a plurality of closely-spaced tines, known generally in the art as a manure fork. The bedding and manure are placed in a wheelbarrow for removal to a dump site.

Much if not most of the removed bedding is not soiled and is still suitable for use as animal bedding. Because a significant portion of the cost of maintaining an animal in such confinement is the cost of bedding, it is common practice in the art of animal husbandry during renewal of bedding to attempt to separate manure and clumps of soiled bedding from non-soiled bedding and to return the non-soiled bedding to the stall floor for further use. Experience has shown that good separation by a skilled operator can be obtained in many instances by gentle shaking or fluffing of the bedding when on the manure fork and raised from the floor, allowing the non-soiled bedding to fall between the tines while the manure clumps and bedding clumps, being larger than the inter-tine spacing, are retained on the tines for transfer to a waste receptacle such as a wheelbarrow. A skilled operator can obtain a very high percentage separation of non-soiled bedding. In equine husbandry, the manure typically is well-defined and relatively dry, and thus is quite amenable to separation.

Unfortunately, this prior art manual process has at least three serious drawbacks.

First, success of the process is highly dependent upon the skill of the fork operator.

Second, the prior art process is relatively time-consuming, as each fork-full must be shaken repeatedly to obtain adequate separation. Thus, labor costs are undesirably high, and operator output is undesirably low.

Third, the prior art process, requiring repeatedly holding and shaking a weight cantilevered by a pitchfork handle from an operator's arms at some distance from an operator's body for some period of time, is stressful to the back of an operator and can be permanently damaging.

Various devices are disclosed in the prior art for separating manure from bedding.

U.S. Pat. No. 6,494,514 B1 to Stinnett et al. discloses a manure fork combined with an air blower directed into the working region of the fork. The air flow is directed to blow the loose bedding material past the fork tines and onto surrounding regions of the stall automatically, while the operator simply works with the fork in a normal manner to remove the manure. The loose bedding material remains in the stall.

A serious problem with such a device is that a blower sufficiently powerful to separate loose bedding material from manure over the full width of the fork will create clouds of bedding dust within the stall, which is unpleasant and hazardous to both the operator and to any animals present.

U.S. Pat. No. 5,927,513 to Hart is directed to a portable shaker frame for separating irregularly-shaped wood shavings used in animal stalls as bedding materials from manure contained in the bedding material. The shaker frame is inclined and suspended on springs carried on a carriage having wheels. The springs permit the shaker frame to vibrate relative to the carriage frame. The shaker frame includes a number of longitudinally extending, substantially parallel, steel rods that are spaced from each to enable wood shavings to pass therethrough while the manure slides downwardly along the rods and into a collection container for disposal. A vibratory motor is positioned on an end panel of the shaker frame for imparting vibratory motion to the rods carried by the shaker frame. The motor is connectable via a switch to a permanent electric source such as a wall outlet.

A problem with the disclosed portable shaker frame is that it is cumbersome, and both it and the collection container must be moved from stall to stall. Further, the electric source is not portable, requiring that the shaker frame be unplugged when leaving one point of use and replugged when reaching the next point of use. Further, the device may be used only in a facility equipped with electric power. Further, when not in use the device consumes significant floor space for parking in the barn.

U.S. Pat. No. 6,334,538 B1 to Nettles discloses a stall cleaner cart that scoops material, such as a mixture of wood shavings and animal manure, sifts selected material out of the scooped material, and collects remaining material in a receptacle. The cleaner includes a stationary portion and a vibrating portion. The stationary portion includes a frame supported by wheels. A scoop is located at the front end of the frame. A handle is provided on a rear end of the frame. The vibrating portion of the apparatus includes a tray that is supported by the frame. The tray has a rigid perimeter that surrounds and supports a plurality of spaced longitudinal elements. A motor rotates an off-center weight to impart vibration to the tray, causing smaller particles to fall through the tray. A receptacle located behind the frame on the apparatus is positioned such that materials slide off of the rear end of the tray into the receptacle.

This device is essentially a wheeled slotted scoop having vibratory means. Although it is battery powered, unlike the device disclosed in the above-discussed '513 patent, it also is cumbersome to operate and requires floor parking space when not in use.

U.S. Pat. No. 6,474,267 to Padgett discloses a pellet fork specifically designed for use with bedding material consisting of compacted and compressed pelletized sawdust particles or granules of relatively uniform size. The device has no vibratory means and teaches away from using such means, stating that a vibrator may cause a horse to become skittish during cleaning of a stall.

U.S. Pat. No. 6,022,058 to O'Rourke discloses a device that is essentially a motorized slotted spoon for separating cat feces and urine clumps from pelletized clay litter a litter box. It is similar in concept but inferior to the improved manure fork that is the subject of the present invention, as fully described below. The cat litter scoop includes a battery powered vibrator carried in the scoop handle which is actuated by a thumb operated switch. Upon actuation, the vibrator imparts a high speed oscillatory movement to the scoop about the longitudinal axis of the handle to accelerate the manual steps of insertion, pushing, lifting, and sifting associated with the scooping motion employed with a standard cat litter scoop. The scoop portion of the cat litter scoop is provided with a pair of spaced, transversely-extending, rows of elongated longitudinal slots so as to define a solid web portion extending between the rows of slots and traversing the scoop to enhance the structural integrity of the scoop portion of the litter scoop. The vibrator includes an electric motor having a weighted eccentric mounted on the motor shaft. The motor is battery powered by a battery disposed within the scoop handle.

For dealing with large-animal manure in stalls, the disclosed scoop is inferior to a manure fork in accordance with the present invention. The scoop could be constructed as a long-handled scoop to make stand-up operation easier by an operator. However, because the ribs of the scoop are constrained at both ends, rather than having freely-projecting tines extending from the shank, the scoop is not able to vibrate as effectively as are the free tines of the vibrating manure fork of the present invention. It will be seen that the analogous “tines” of the prior art scoop, because they are constrained at both ends, are not able to vibrate with respect to one another and thereby change the intertine spacing. The prior art motorized scoop thus functions as a shaker sieve wherein the entire device moves back and forth. As will become apparent when reading the detailed disclosure below, the improved manure fork of the present invention functions by a different mechanism wherein the free-ended tines vibrate independently of one another and thus can change dynamically the intertine spacing to encourage bedding to fall between the tines. The vibration causes each bedding particle to be repeatedly reoriented on the tines until an orientation occurs in which the particle cannot bridge the intertine space and thus falls through. It is not necessary for the entire manure fork to oscillate.

The '058 patent also discloses to form the motor, switch, battery, contacts, and wires as a module which may be disconnected from the scoop to permit washing of the scoop. However, the disclosure does not suggest that such a module may be useful in its own right to be connected onto prior art scoops to enable them to perform like the disclosed scoop.

What is needed in the art is a manure fork that can rapidly and efficiently separate manure from bedding.

What is further needed in the art is a means for converting a prior art manure fork to an improved manure fork that can rapidly and efficiently separate manure from bedding.

It is a principal object of the present invention to separate manure from bedding in an animal stall.

It is a further object of the invention to reduce the cost of maintaining an animal in confinement.

It is a still further object of the invention to reduce the risk of injury to farm workers responsible for cleaning animal stalls.

It is a still further object of the invention to increase the productivity of farm workers responsible for cleaning animal stalls.

### SUMMARY OF THE INVENTION

Briefly described, a manure fork improved in accordance with the invention comprises a longitudinal handle to which is attached a fork arrangement comprising a shank terminating in a plurality of tines. The shank and tines typically are formed by injection molding of a durable polymer, for example, polycarbonate, although older fork arrangements are formed of steel as by forging. The tines are integral with the shank at an inner end and are free at the outer end. Each tine, therefore, is a resonant leaf spring attached at only one end and as such is capable of being energized into resonant motion at its resonant frequency.

A manure fork typically includes a relatively large number of tines in comparison with other agricultural forks such as hay forks, for example, nineteen tines, closely-spaced for retaining and conveying relatively small pieces of manure. The free end of the handle may be unfeatured or may terminate in a transverse handle arrangement for gripping with one hand by an operator. Switch means may be provided in the handle, as well as means for recharging a rechargeable battery.

A means for causing the tines to vibrate is incorporated into the manure fork, preferably at a point relatively near to the juncture of the handle and shank, on either the handle or the shank.

In a presently-preferred embodiment, the means for vibrating is an auxiliary motor unit, battery, and switch attachable to the handle of a prior art manure fork to convert any prior art manure fork into a improved manure fork in accordance with the invention. In an alternative embodiment, the means for vibrating may be incorporated within the handle itself as by molding the handle of plastic and forming a pocket therein for receiving the auxiliary unit.

A currently-preferred means for vibrating includes a DC electric motor provided with an eccentric weight mounted on an output shaft thereof such that the entire motor assembly is caused to shake during rotation of the shaft. Preferably, the motor is battery powered by an associated portable battery source, preferably also mounted on the manure fork, and preferably the battery source is rechargeable by a transformer/rectifier connected to a remote AC outlet.

A switch is provided on the handle, preferably in proximity to either of an operator's hands, such that the motor may be energized when vibration is desired and de-energized to conserve battery power during scooping or dumping portions of the bedding renewal task.

### BRIEF DESCRIPTION OF THE DRAWINGS

The present invention will now be described, by way of example, with reference to the accompanying drawings, in which:

FIG. 1 is an isometric view of a prior art vibrating cat litter scoop substantially as disclosed in U.S. Pat. No. 6,022,058 to O'Rourke;

FIG. 2 is an elevational view of the scoop shown in FIG. 1, showing a vibration-causing mechanism in phantom;

FIG. 3 is an isometric view of a portion of a prior art vibration-causing mechanism suitable for use in accordance with the present invention;

FIG. 4 is an elevational side view of an improved vibrating manure fork in accordance with the invention;

FIG. 5 is an elevational cross-sectional frontal view of an alternative embodiment of a manure fork handle, showing an embedded switch and a battery recharging receptacle;

FIG. 6 is an elevational frontal view of the vibrating manure fork shown in FIG. 4; and

FIG. 7 is a schematic electrical circuit for the vibrating mechanism shown in FIGS. 4 and 6.

The exemplification set out herein illustrates one preferred embodiment of the invention, in one form, and such exemplification is not to be construed as limiting the scope of the invention in any manner.

### DESCRIPTION OF THE PREFERRED EMBODIMENTS

The benefits and advantages of the present invention will be better appreciated by first considering a similar prior art invention which is inferior to the present invention for easy separation of large-animal manure from non-soiled bedding.

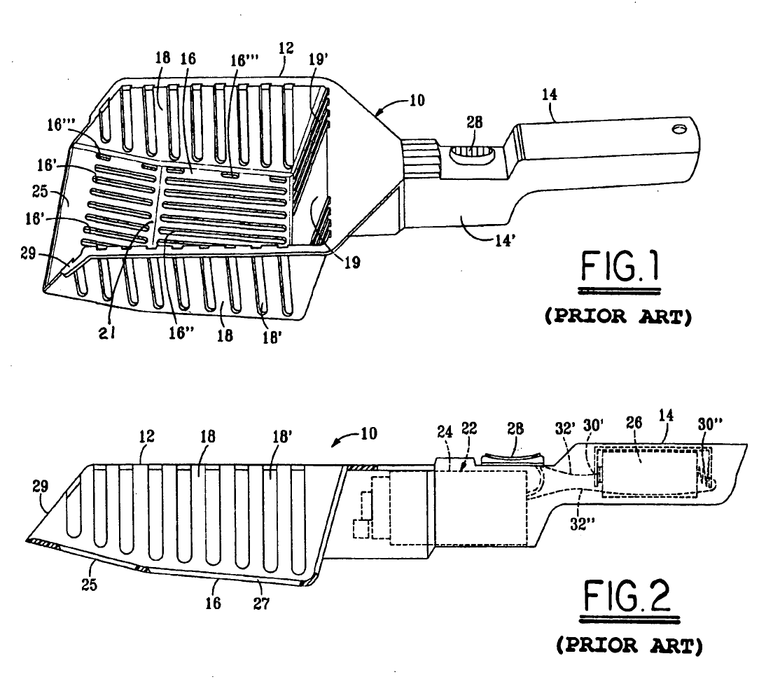

Referring to FIG. 1, a prior art cat litter scoop device 10 as disclosed in U.S. Pat. No. 6,022,058 is formed of molded plastic and comprises a forward scoop portion 12 and a handle portion 14. The forward scoop portion 12 is defined by a slotted bottom wall 16 and slotted side walls 18 and a slotted rear wall 19 which project upwardly from the bottom wall 16. The bottom wall 16 defines a forwardly disposed transverse row of longitudinally extending parallel slots 16′, a second transverse row of longitudinally extending parallel slots 16″, and a plurality of aligned slots 16′″ laterally spaced from the rows of slots 16′ and 16″. Elongated slots 16″ are greater in length than 16′ so as to define a solid transverse web 21 extending across the scoop bottom wall 16 forwardly of the midpoint thereof. The upstanding side walls 18 and rear wall 19 are provided with a plurality of vertically disposed slots 18′ and 19′, respectively. Slots 19′ are positioned on opposed lateral sides on a centrally disposed solid wall portion 19″ for additional structural strength at the juncture of the handle and scoop portions of the device. The bottom wall 16 is separated by web 21 into a forward portion 25 and rearward portion 27. Portion 27 is inclined upwardly with respect to a central longitudinal axis passing through the handle portion 14 of the device 10 at an angle of about 5.degree. The forward portion 25 of bottom wall 16 is inclined upwardly at an angle of about 15 degrees. The forward edge 29 of side walls 18 is inclined rearwardly at an angle of about 40 degrees with respect to a vertical axis passing therethrough. The handle portion 14 of the litter scoop device 10 is hollow so as to define a housing for a vibrating mechanism 22 (FIG. 2). The lower end of the handle is preferably open to allow for the insertion of the vibrating mechanism 22 and a cover (not shown) is removably attached to the handle so as to fully encase the vibrating mechanism while defining a lower surface for the handle portion 14.

The prior art vibrating mechanism 22 comprises a DC motor 24, a battery 26, preferably an AA battery, and a push button on/off switch 28 which projects through the upper surface of the handle and is disposed at the “thumb” position to facilitate movement between the on and off positions. The battery 26 is held between contact members 30′ and 30″ which are in electrical communication with DC motor 24 via leads 32′ and 32″. An eccentrically mounted weight 34, preferably formed of lead, is mounted on the motor shaft 36 as seen in FIG. 2. Shaft 36 is substantially coincident with the central axis of the handle portion 14. Motor 24 is rigidly affixed within an enlarged portion 14′ of handle 14 and is disposed adjacent the interior handle walls of the scoop such that vibration of the motor 14 is transmitted to the handle portion 14 and thus scoop 10. The off-center mounting of weight 34 on shaft 36 causes vibration of the motor 24 and of the entire scoop 10 in the nature of an oscillatory motion about the longitudinal axis of the handle. As the forward portion of the scoop 12 is caused to vibrate, the finer unsoiled litter particles will pass through the various slots in scoop portion 12, leaving only the soiled “clumps” remaining within the scoop portion 12 for easy disposal.

As noted above, for dealing with large-animal manure in stalls, the prior art cat litter scoop is inferior to a manure fork in accordance with the present invention. Even if constructed as a long-handled scoop to make stand-up operation easier by an operator, the ribs of the scoop are constrained at both ends, rather than having freely-projecting sharpened tines extending from the shank. It will be seen that the analogous “tines” of the prior art scoop, because they are constrained at both ends, are not tines at all and are not able to vibrate with respect to one another and thereby change the intertine spacing. Thus, the scoop is not able to vibrate as effectively as are the free tines of the vibrating manure fork of the present invention. The prior art motorized scoop thus functions as a shaker sieve wherein the entire device moves back and forth.

Further, a scoop having a shovel-type end such as forward portion 25 is decidedly more difficult to drive through stall bedding and manure than is a fork having sharp-ended, spaced-apart tines, especially when such bedding is fibrous and comprises wood shavings or the like. The recited prior art disclosure does not suggest or teach to make the scoop in the form of a fork and, in fact, teaches away from such a construction in disclosing a solid transverse web 21 extending across the scoop bottom wall 16 forwardly of the midpoint thereof to enhance the structural integrity of scoop portion 12.

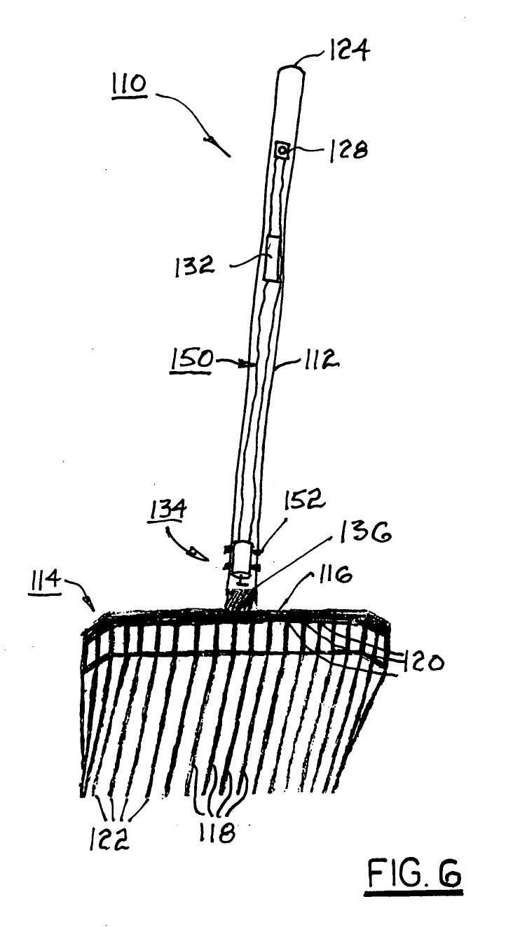

Referring to FIGS. 4 through 7, an improved manure fork assembly 110 in accordance with the invention comprises a longitudinal handle 112 to which is attached at a distal end thereof a fork arrangement 114 comprising a shank 116 terminating in a plurality of spaced-apart tines 118, preferably about eighteen tines. The shank 116 and tines 118 of a modern manure fork arrangement typically are formed by injection molding of a durable polymer, for example, polycarbonate, whereas older prior art fork arrangements are formed of steel as by forging. Either polymeric or metal fork arrangements are suitable for use with the present invention. Tines 118 are integral with shank 116 at inner ends 120 thereof and are free at the outer ends 122 thereof.

The proximal end 124 of handle 112 may be unfeatured or (FIG. 5) may terminate in a transverse handle arrangement 126 for gripping with one hand by an operator. Switch means 128 may be provided in transverse handle arrangement 126 (or within an operator's thumb reach on an unfeatured handle 112, as shown in FIGS. 4 and 6), which may further comprise a receptacle 130 for recharging a rechargeable embodiment of battery 132 which preferably is mounted on handle 112.

A means 134 for causing the tines to vibrate is incorporated into manure fork assembly 110, preferably at a point relatively near to the juncture 136 of the handle and shank, and may be mounted on either the handle or the shank, which location maximizes the effectiveness of the vibrating and minimizes operator fatigue from vibrations.

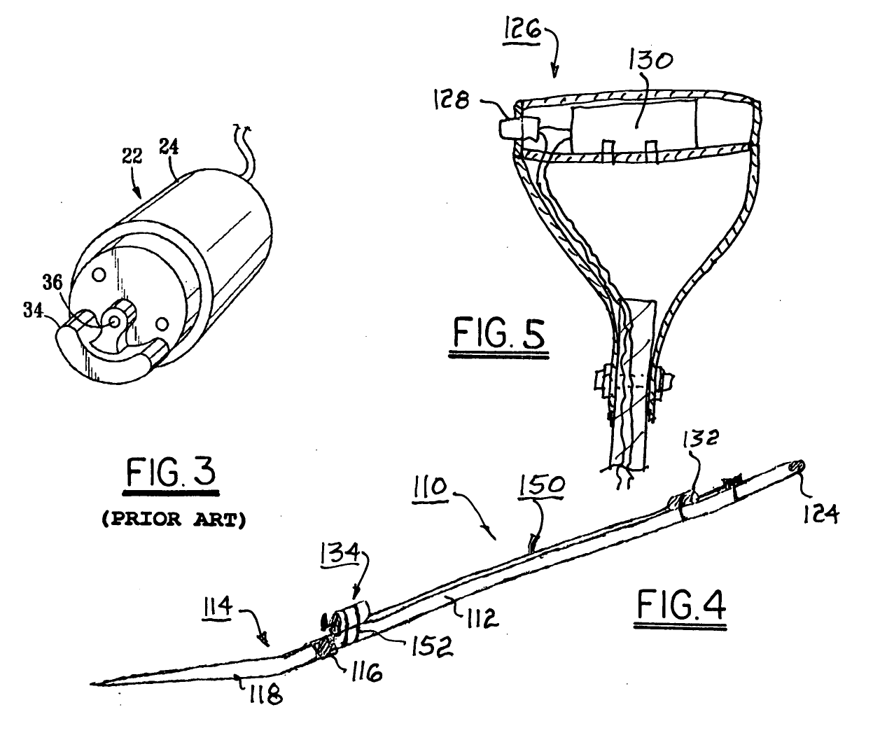

A currently-preferred means for vibrating 134 is substantially as shown in FIG. 3 as prior art embodiment 22, comprising a DC electric motor 24 provided with an eccentric weight 34 mounted on an output shaft 36 thereof such that the entire motor assembly is caused to shake during rotation of the shaft. Motor 24 is battery powered by battery source 132 (FIGS. 4 and 6), which may be non-rechargeable but preferably is rechargeable by a transformer/rectifier (not shown) connected to a remote AC outlet (not shown), whereby the entire fork assembly 110 may be conveniently hung on receptacle 130 for automatic recharging of battery 132 when the fork assembly is not in service.

Switch 132 as provided on either handle 112 or transverse handle arrangement 126 is located in proximity to one of an operator's hands such that the motor may be readily energized when vibration is desired and de-energized to conserve battery power during scooping or dumping portions of the bedding renewal task when vibration is not required.

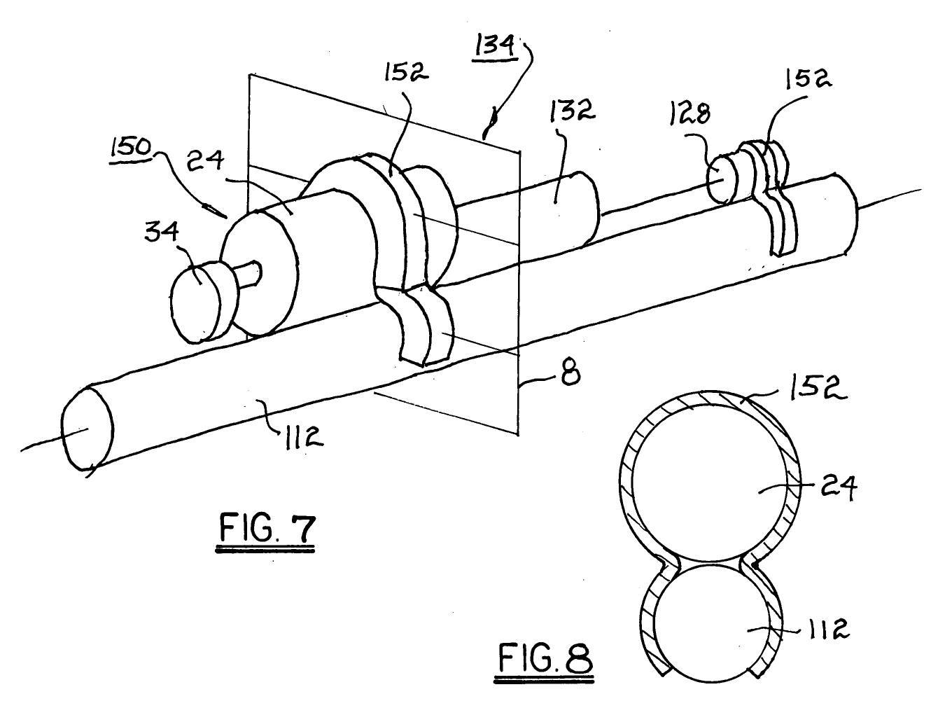

In a presently-preferred embodiment, the means for vibrating 134 is an auxiliary module 150 (FIG. 7) comprising motor 24 with eccentric weight 34, battery 132, and switch 128 attachable to the shank and handle of a prior art manure fork to convert any prior art non-vibrating manure fork not so equipped into an improved manure fork in accordance with the invention. Attachment, whether removable or permanent, may be carried out via any convenient means 152 that assures a solid mechanical connection of the vibration-causing means onto the manure fork, for example, spring clips, screws, bolts, cable ties, radiator clamps, and the like. In an alternative embodiment, the means for vibrating may be incorporated within the handle or shank itself as by molding the handle or shank of plastic and forming a pocket (not shown) therein for receiving the auxiliary module.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. (canceled)

2. (canceled)

3. (canceled)

4. (canceled)

5. (canceled)

6. (canceled)

7. (canceled)

8. (canceled)

9. A vibration-causing auxiliary module, comprising:
a) an electric motor having a drive shaft extending therefrom;
b) an eccentric weight mounted on said drive shaft for rotation therewith to excite vibration of said auxiliary module; and
c) means for attaching said vibration-causing auxiliary module to a longitudinal handle extending from a fork arrangement of any non-vibrating manure fork to convert said non-vibrating manure fork into a vibrating manure fork.

10. (canceled)

11. A vibration-causing auxiliary module in accordance with claim 9 further comprising battery means for powering said electric motor.

12. A vibration-causing auxiliary module in accordance with claim 11 wherein said battery means is selected from the group consisting of rechargeable and non-rechargeable.

13. In a manure fork assembly wherein a fork arrangement is attached to a longitudinal handle to permit shaking of used animal bedding material when placed in said fork arrangement in order to separate manure from non-soiled bedding material, the improvement comprising:
a vibration-causing auxiliary module attached to said longitudinal handle for causing said handle and said fork arrangement to vibrate, said vibration-causing module including an electric motor having a drive shaft extending therefrom, an eccentric weight mounted on said drive shaft for rotation therewith to excite vibration of said module, and means for attaching said module to said longitudinal handle to transmit said vibration to said fork arrangement to cause said separation,
wherein said means for attaching permits attachment of said module to any such manure fork assembly having a fork arrangement attached to a longitudinal handle.

14. An improvement in accordance with claim 13 wherein said means for attaching is selected from the group consisting of spring clips, screws, bolts, cable ties, radiator clamps, and combinations thereof.

15. A method for forming a vibrating manure fork, comprising the steps of:
a) providing a non-vibrating manure fork having a fork arrangement attached to a longitudinal handle;
b) providing a vibration-causing auxiliary module including an electric motor having a drive shaft extending therefrom, an eccentric weight mounted on said drive shaft for rotation therewith to excite vibration of said auxiliary module, and means for attaching said vibration-causing auxiliary module to said non-vibrating manure fork; and
c) attaching said vibration-causing auxiliary module to said non-vibrating manure fork to yield said vibrating manure fork.

16. A method in accordance with claim 15 wherein said non-vibrating manure fork is without mating means specifically provided for receiving said vibration-causing auxiliary module.
